(19) United States
(12) Patent Application Publication
(10) Pub. No.: US 2018/0054099 A1
(43) Pub. Date: Feb. 22, 2018

(54) ROTOR OF AN ELECTRICAL ROTATING MACHINE WITH PERMANENT MAGNETS

(71) Applicant: VALEO EQUIPEMENTS ELECTRIQUES MOTEUR, Creteil Cedex (FR)

(72) Inventors: Benoit WALME, Feucherolles (FR); Mamy RAKOTOVAO, Vitry Sur Seine (FR); Nam-Gook KIM, Saint-maurice (FR)

(21) Appl. No.: 15/556,578

(22) PCT Filed: Feb. 19, 2016
(86) PCT No.: PCT/FR2016/050378

§ 371 Date: Sep. 7, 2017

(30) Foreign Application Priority Data
Mar. 16, 2015 (FR) 1552134

(51) Int. Cl. H02K 1/27; H02K 1/28

(52) U.S. Cl. CPC H02K 1/276; H02K 1/28

(57) ABSTRACT

The invention mainly relates to a rotor (10) of an electrical rotating machine, comprising a rotor body (11) and a set of permanent magnets (22), and wherein a ratio between a space occupied by all of the permanent magnets (22) and a space (V) defined by the rotor body (11) is higher than 30%, preferably higher than 50%.

The invention relates to a rotor of an electrical rotating machine with permanent magnets providing improved magnetic performance.

In a commonly known way, the electrical rotating machine comprises a stator and a rotor integral with a shaft. The rotor can be integral with a driving and/or driven shaft and can belong to an electrical rotating machine in the form of an alternator, electric motor or reversible machine able to function in the two modes.

The stator is mounted in a casing configured to rotationally support the shaft for example via bearings. The stator comprises a body made from a laminated core of thin laminae forming a crown, the internal face of which is equipped with slots open towards the interior to receive phase windings. In a winding of the distributed wave type, windings are obtained for example from a continuous wire coated with enamel or from conductive elements in the form of pins held together by welding. Alternatively, in a winding of the “concentric” type, phase windings consist of closed coils which are wound around the teeth of the stator. Protection between the laminated core and the winding wire is assured either by a paper-type insulator or by a plastic moulding or by means of an insert. Windings are poly-phase windings joined by star or delta connections, the outputs of which are connected to an electronic control unit.

In addition, the rotor comprises a body formed by a laminated core kept in the form of pack by means of a suitable attachment system, such as rivets axially passing right through the rotor or with staples or even with buttons. The rotor comprises poles formed by permanent magnets accommodated in slots arranged in the rotor body.

Electrical rotating machines coupled with an electric turbo-compressor shaft are well-known (“electric supercharger” in English). This turbo-compressor at least partly enables the loss of power of the internal combustion engine with reduced cubic capacity used on many motor vehicles to be compensated, in order to decrease their consumption and their emission of polluting particulates (principle known as “downsizing” in English). For this purpose, the electric turbo-compressor comprises a compressor turbine. The compressor is disposed on the air-intake conduit upstream or downstream from the internal combustion engine to enable the intake air to be compressed so that the cylinders of the internal combustion engine are filled to the maximum.

The electrical machine is activated to drive the turbine of the compressor in order to minimize the coupling response time, particularly during the transitional acceleration stages, or in the automatic restarting phase of the internal combustion engine after its deactivation (“stop and start” operation in English).

The object of the invention is to improve the magnetic performances of this type of electrical machine which is very compact and the speed of which can reach 70000 rpm, particularly 60000 to 80000 rpm.

For this purpose, the object of the invention is a rotor of an electrical rotating machine particularly of an electrical machine able to rotate at a speed of about 60000 to 80000 rpm, comprising:
a rotor body and
a set of permanent magnets,
   characterized in that a ratio between a space occupied by the set of permanent magnets and a space defined by said rotor body is higher than 30%, for example higher than 45%, preferably higher than 50%.

This arrangement allows the machine equipped with a compact rotor to provide high specific power while reducing the inertia of the rotor.

According to an embodiment, the rotor body is made of metal and the space defined by the rotor body is equal to the volume of metal of said body.

According to an embodiment, said permanent magnets are made of rare earth.

According to an embodiment, an external diameter of said rotor ranges between 20 mm and 50 mm, particularly between 24 mm and 30 mm, for example between 20 mm and 35 mm.

This type of rotor is particularly suitable for high speeds, particularly about 60000 to 80000 rpm.

According to an embodiment, said external diameter of said rotor is about 26 mm.

According to an embodiment, the rotor comprises four poles.

According to an embodiment, a ratio between a volume of air in said rotor body and a space of the set of permanent magnets is higher than 10%. This enables the inertia of the rotor to be minimized and hence the acceleration performance of the electrical machine to be improved.

Preferably, said ratio is approximately 20%.

According to an embodiment, said rotor body comprises a plurality of slots each accommodating at least one magnet of the set of permanent magnets.

According to an embodiment, each slot axially passes right through said rotor.

According to an embodiment, each slot is defined on its external periphery by a polar wall.

According to an embodiment, said polar wall comprises an inner face in contact with a permanent magnet.

According to an embodiment, said inner face is flat.

Alternatively, said inner face is curved.

According to an embodiment, two adjacent slots are separated by an arm pertaining to said rotor body.

According to an embodiment, each arm is connected to a polar wall via a bridge.

Preferably, a ratio between a minimum thickness of a bridge measured in a radial direction and the radius of the rotor ranges between 6% and 15%, particularly between 8% and 10%.

According to an embodiment, a minimum thickness of a bridge measured in a radial direction is strictly lower than a minimum thickness of a corresponding polar wall measured in a radial direction.

Preferably, the thickness of the bridges measured in a radial direction is higher than or equal to 1.2 mm, for example substantially equal to 1.2 mm.

Preferably, the thickness of the bridges measured in a radial direction is lower than or equal to 1.5 mm.

According to an embodiment, a minimum thickness of a bridge measured in a radial direction is strictly lower than a measured minimum thickness of an arm in an orthoradial direction.

Preferably, the thickness of the arm measured in an orthoradial direction is higher or equal to 1.5 mm, for example substantially equal to 1.5 mm.

Preferably, the thickness of the arm measured in an orthoradial direction is lower than or equal to 3.5 mm.

According to an embodiment, a ratio between a minimum thickness of a bridge and a minimum thickness of an arm ranges between 30% and 80%. This enables a good compromise between the magnetic flux of the machine and the mechanical resistance of the rotor to be obtained.

According to an embodiment, an angular opening of each permanent magnet is at least equal to 30°.

According to an embodiment, said permanent magnets have radial magnetization.

According to an embodiment, said rotor body consists of a laminated core or is a solid block.

According to an embodiment, each slot has an angular opening strictly higher than 30°, particularly strictly higher than 40°.

According to an embodiment, each permanent magnet is substantially in the form of a rectangular parallelepiped.

According to an embodiment, each permanent magnet is substantially in the form of a tile or has a combined form with a flat face on one side and a curved face on the other.

According to an embodiment, the rotor body has an external periphery having a cylindrical face substantially in the form of that of a cylinder.

Such a rotor enables the inductance (Lq) in the axis passing between the permanent magnets to be increased. This enables a reluctance torque which contributes to the production of engine torque at high-speed to be obtained. This is particularly suitable for electrical machines rotating at high-speed, namely at speeds of at least 60000 rpm.

Another object of the invention is an electrical rotating machine rotor comprising:
a rotor body and
a set of permanent magnets,
   the rotor body comprising a plurality of slots each accommodating at least one magnet of the set of permanent magnets, each slot being defined on its external periphery by a polar wall, two adjacent slots being separated by an arm pertaining to said rotor body, each arm being connected to a polar wall via a bridge, a ratio between a minimum thickness of a bridge measured in a radial direction and the radius of the rotor ranging between 6% and 15%, particularly between 8% and 10%.

According to an embodiment, the external diameter of the rotor is about 26 mm.

All or some of the features mentioned previously again apply to this further aspect of the invention.

Another object of the invention is an electrical rotating machine comprising a coiled stator and a rotor as previously defined.

According to an embodiment, said electrical rotating machine has a response time of about 250 ms in order to change from 5000 to 70000 rpm.

According to an embodiment, the operating voltage is 12V and the current in permanent mode is about 150 Amps.

According to an embodiment, an external diameter of the stator ranges between 35 mm and 80 mm, particularly between 45 mm and 55 mm, for example between 48 mm and 52 mm.

The final object of the invention is a rotor of an electrical rotating machine, particularly of an electrical machine, able to rotate at a speed of about 60000 to 80000 rpm, comprising:
a rotor body and
a set of permanent magnets,
   characterized in that, in a plane orthogonal to the axis of the rotor, a ratio between a surface defined by the set of permanent magnets, divided by a surface defined by said rotor body, is higher than 30%, for example higher than 45%, and preferably higher than 50%.

All or some of the features mentioned previously again apply to this further aspect of the invention.

The invention will be understood better on reading the description below and on examining the figures which accompany it. These figures are only given on a purely illustrative, but by no means restrictive, basis of the invention.

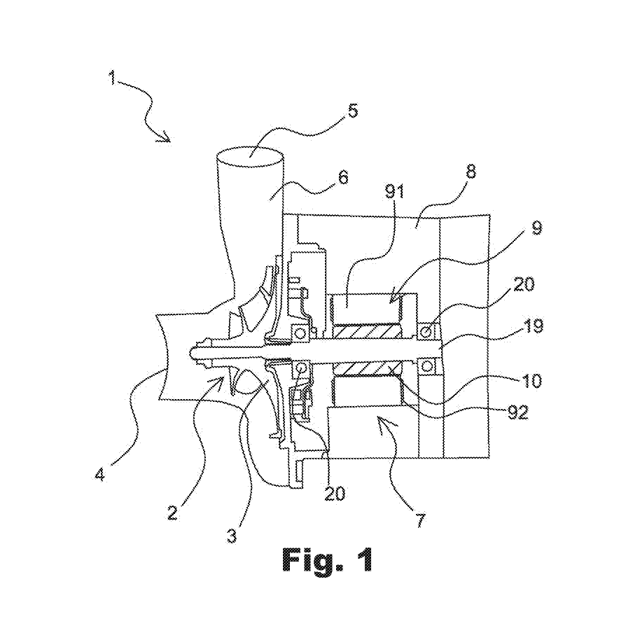

FIG. 1 is a sectional view of a turbo-compressor comprising an electrical rotating machine according to the present invention;

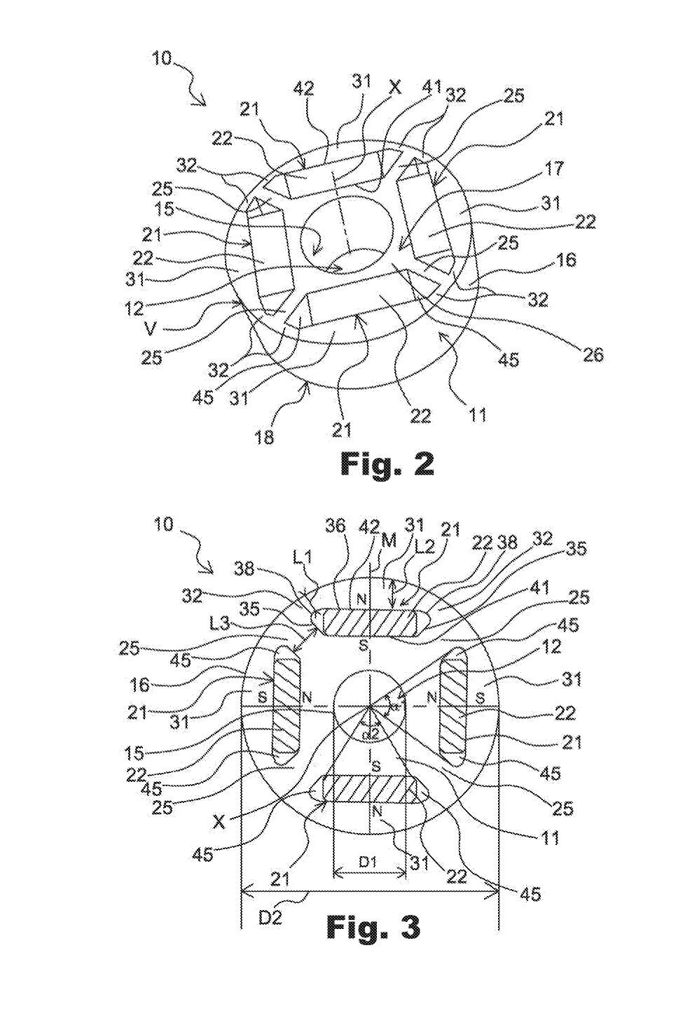

FIG. 2 shows a perspective view of the rotor for the electrical rotating machine according to the present invention;

FIG. 3 is a sectional view of the rotor of the electrical rotating machine according to the present invention;

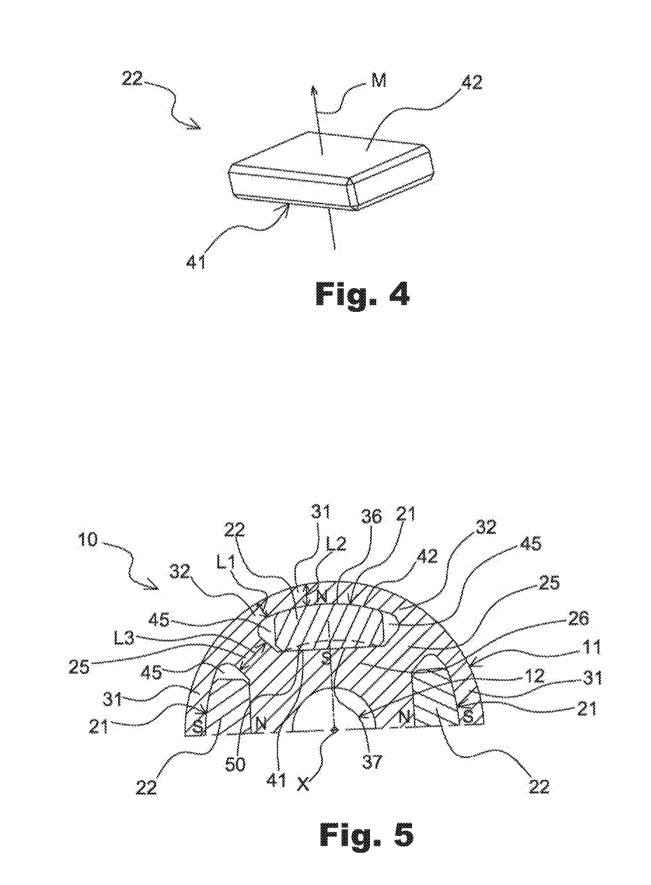

FIG. 4 is a perspective view of a permanent magnet intended to be inserted inside a slot of the rotor according to the present invention;

FIG. 5 shows a partial sectional view illustrating an alternative embodiment of the rotor of the electrical machine according to the present invention.

Identical, similar or analogous elements keep the same reference symbol from one figure to the next.

FIG. 1 shows a turbo-compressor 1 comprising a turbine 2 provided with vanes 3 able to take in, via an inlet 4, uncompressed air resulting from a source of air (not illustrated) and to expel compressed air via outlet 5 after passing through a volute with the reference symbol 6. Outlet 5 could be connected to an intake manifold (not illustrated) located upstream or downstream from the internal combustion engine so that the cylinders of the internal combustion engine are filled to the maximum. In this case, the intake of the air is performed in an axial direction, i.e. along the axis of turbine 2, and compression is performed in a radial direction perpendicular to the axis of turbine 2.

Alternatively, air intake is radial while compression is axial.

Alternatively, air intake and compression are performed in the same direction relative to the axis of the turbine (axial or radial).

For this purpose, turbine 2 is driven by an electrical machine 7 mounted inside casing 8. This electrical machine 7 comprises a stator 9, which could be poly-phase, surrounding a rotor 10 with the presence of an air-gap. This stator 9 is mounted in casing 8 configured to rotationally support a shaft 19 via bearings 20. Shaft 19 is fixed in rotation with turbine 2 as well as with rotor 10. Stator 9 is preferably mounted in casing 8 by shrink-fitting.

In order to minimize the inertia of turbine 2 at the time of a request for acceleration by the driver, electrical machine 7 has a short response time ranging between 100 ms and 600 ms, particularly between 200 ms and 400 ms, for example about 250 ms in order to change from 5000 to 70000 rpm. Preferably, the operating voltage is 12 V and the current in permanent mode is about 150 A. Preferably, electrical machine 7 is able to provide a current peak, i.e. a current supplied over a continuous duration of less than 3 seconds, ranging between 150 A and 300 A, particularly between 180 A and 220 A. Alternatively, electrical machine 7 is able to function in alternator mode or is an electrical machine of the reversible type.

More precisely, stator 9 comprises a body made from a laminated core of thin laminae forming a crown, the internal face of which is equipped with slots open towards the interior to receive phase windings. In a winding of the distributed wave type, the windings are obtained for example from a continuous wire coated with enamel or from conductive elements in the form of pins joined together by welding. Alternatively, in a winding of the “concentric” type, phase windings consist of closed coils which are wound around the teeth of the stator. Protection between the laminated core and the winding wire is assured either by a paper-type insulator or by plastic mouldings or by means of an insert. These windings are poly-phase windings joined by star or delta connections, the outputs of which are connected to an inverter.

Rotor 10 of rotational axis X shown in more detail on FIG. 2 has permanent magnets. Rotor 10 comprises a body 11 formed here by a laminated core extending in a radial plane perpendicular to axis X in order to reduce any eddy currents. This body 11 is made of ferromagnetic material. The laminae are retained by fixing means, for example rivets, axially passing right through the laminated core to form an easy-to-handle and transportable unit.

Alternatively, the laminae are joined together by means of staples or buttons. Body 11 can be fixed in rotation to the shaft of the electrical rotating machine in various ways, for example by hafting the fluted shaft with force inside central opening 12 of rotor 10, or using a key device. Alternatively, rotor body 11 could be cast from solid ferromagnetic material.

Rotor body 11 has an internal periphery 15 defining central cylindrical opening 12 having an internal diameter D1 for example of about 10 mm, an external periphery 16 defined by a cylindrical face having an external diameter D2 for example of about 26 mm, but more generally able to range between 20 mm and 50 mm, particularly between 24 mm and 30 mm, as well as by two axial end-faces 17, 18 of annular form extending in a radial plane between internal periphery 15 and external periphery 16. A space V of rotor body 11 is defined by internal periphery 15, external periphery 16 and the two axial end-faces 17, 18. In other words, space V of rotor body 11 is that defined by the laminated core of the rotor body. In addition, an external diameter of the stator ranges between 35 mm and 80 mm, particularly between 45 mm and 55 mm, and preferably for example between 48 mm and 52 mm.

Rotor 10 comprises a plurality of slots 21 in each of which a permanent magnet 22 is accommodated. In order to optimize the magnetic performance of the machine, the ratio between the space occupied by the set of permanent magnets 22 and space V defined by rotor body 11 is higher than 30%, preferably higher than 50%.

More precisely, each slot 21 axially passes right through body 11, i.e. from one axial end-face 17, 18 to the other. Two adjacent slots 21 are separated by an arm 25 emerging from a core 26 of rotor 10, so that an alternation of slots 21 and arms 25 exists whenever a circumference of rotor 10 is followed. Rotor body 11 also comprises polar walls 31 each located between two adjacent arms 25. Each polar wall 31 extends between an inner face 36 in contact with a permanent magnet 22 and the external periphery of rotor 10. Moreover, each arm 25 is connected to a corresponding polar wall 31 via a bridge 32.

Thus, as FIG. 3 shows, slots 21 are each defined by two faces 35 of two adjacent arms 20 facing one another, an inner flat face 36 of a polar wall 31 extending in an orthoradial direction, a flat face 37 arranged in core 26 parallel with face 36 and inner faces 38 of two bridges 32. The junctions between faces 35 and 38 could be rounded in order to facilitate machining.

In the exemplary embodiment, a minimum thickness L1 of a bridge 32 measured in a radial direction relative to axis X is strictly lower than a minimum thickness L2 of a corresponding polar wall 31 measured in a radial direction relative to axis X.

In addition, the minimum thickness L1 of a bridge 32 is strictly lower than a minimum thickness L3 of an arm 25 measured in an orthoradial direction relative to axis X. A ratio between a minimum thickness L1 of a bridge 32 measured in a radial direction and the external radius (D2/2) of the rotor ranges between 6% and 15%, particularly between 8% and 10%.

Preferably, a ratio between the minimum thickness L1 of a bridge 32 and the minimum thickness L3 of an arm 25 ranges between 30% and 80%. This enables a good compromise between the magnetic flux of the machine and the mechanical resistance of magnets 22 to be obtained inside slots 21 of rotor 10.

In the example considered, the L1 thickness of bridges 32 is approximately equal to 1.2 mm and the L3 thickness of arms 25 is approximately equal to 1.5 mm. In all cases, the minimum thickness L1 of the bridges is lower than or equal to 1.5 mm and the minimum thickness L3 of the arms is lower than or equal to 3.5 mm.

It should be noted that “minimum” thickness L1-L3 of an element is understood to mean the smallest thickness measured in the given direction (radial or orthoradial direction) corresponding to the smallest dimension of the smallest section of the element, the thickness of which is to be measured.

Alternatively, the thicknesses L1, L2 of bridge 32 and polar wall 31 are equal and substantially constant, while having a value higher than or equal to 1.2 mm.

In this case, as quite visible on FIG. 4, magnets 22 have a rectangular parallelepiped form, the angles of which are slightly chamfered. Magnets 22 hence present a rectangular cross section which is substantially constant.

Magnets 22 have radial magnetization, i.e. the two faces 41, 42 parallel in relation to each other having an orthoradial orientation are magnetized so as to be able to generate a magnetic flux in a radial direction M relative to axis X. Among these parallel faces 41, 42, inner face 41 located on the side of the axis of rotor 10 and outer face 42 located on the side of the external periphery of rotor 10 are evident.

As quite visible on FIGS. 3 and 5 where letters N and S correspond to the north and south poles respectively, magnets 22 located in two consecutive slots 21 have alternate polarities. Thus, from one slot 21 to the other, inner faces 41 of magnets 22 supported against flat face 37 arranged in core 26 have alternate polarity and outer faces 42 of magnets 22 in contact with inner face 36 of the corresponding polar wall 31 have alternate polarity.

Inner 41 and outer 42 faces of each magnet 22 are level in this case. Alternatively, as illustrated on FIG. 5, outer face 42 of each magnet 22 is curved, while inner face 41 of magnet 22 is flat, or vice versa. Inner face 36 of polar wall 31 then has a corresponding curved form. Hence the retention of magnet 22 inside a slot 21 is improved. Alternatively, the two side faces 41 and 42 are curved in the same direction (see dotted line 50), so that magnet 22 generally has a tile shape.

In addition, magnets 22 do not fill slots 21 completely, so that there are two empty spaces 45 on both sides of magnet 22. The volume of air defined by all spaces 45 of rotor 10 enables the inertia of rotor 10 to be reduced. In order to minimize this inertia in an optimum way and hence improve the acceleration performance of the electrical rotating machine, the ratio between the volume of air in rotor body 11 and a volume of the set of permanent magnets 22 is higher than 10%. Preferably the ratio is approximately 20%.

For this purpose, angular opening α1 of a slot 21 is higher than the angular opening α2 of a corresponding permanent magnet 22. The angular opening α1, α2 of a given element (slot 21 or magnet 22) is defined by the angle formed by two planes each passing through axis X and through one of the ends of said element. In an exemplary embodiment, angular opening α1 of each slot 21 is strictly higher than 40°, while the angular opening α2 of a magnet 22 is at least 30°. In a particular exemplary embodiment, angular opening α1 of each slot 21 is about 73°, while the angular opening α2 of a magnet 22 is about 67°.

Magnets 22 are preferably made of rare earth in order to maximize the magnetic power of the machine. Alternatively however, they could be made of ferrite according to application and the required power of the electrical machine. Alternatively, magnets 22 can be made of different materials to reduce the costs. For example, a rare earth magnet and a less powerful but less expensive ferrite magnet can be used alternately in the slots. Certain slots 21 could also be left empty according to the required power of the electrical machine. For example, two diametrically opposite slots 21 can be empty. The number of slots 21 here is equal to four, just as the number of associated magnets 22. It is however possible to increase the number of slots 21 and magnets 22 according to application.

In addition, a single permanent magnet 22 is inserted inside each slot 21. Alternatively, several magnets 22 stacked over one another inside the same slot 21 could be used. For example two permanent magnets 22 stacked axially or orthoradially over one another, which, as the case may be, can be made from different materials, could be used.

Rotor 10 could also comprise, inside each slot 21, a spring-type mounting element for the magnets or pin made from a magnetic material which is more flexible than magnets 22. These mounting elements permit easier insertion of magnets 22 in slots 21 which is performed by making magnets 22 slide parallel with axis X of rotor 10 and guarantee the mechanical mounting of the magnets. Alternatively, the magnets can be held in the slot by an adhesive.

Rotor body 11 can also comprise two retention plates (not illustrated) arranged on both sides of rotor 10 on its axial end faces. These retention plates ensure magnets 22 are axially held inside slots 21 and also serve to balance the rotor. The flanges are made of non-magnetic material, for example aluminium.

Of course, the above description was only given by way of example and does not restrict the scope of the invention from which there would be no departure if the various elements were replaced by any other equivalents.

1. Rotor (10) of an electrical rotating machine, particularly of an electrical machine, able to rotate at a speed of about 60000 to 80000 rpm, comprising:
a rotor body (11) and
a set of permanent magnets (22),
wherein a ratio between a space occupied by the set of the permanent magnets (22) and a space (V) defined by said rotor body (11) is higher than 30%, for example higher than 45%, preferably higher than 50%.

2. Rotor according to claim 1, wherein said permanent magnets (22) have radial magnetization (M).

3. Rotor according to claim 1, wherein an external diameter of said rotor (10) ranges between 20 mm and 50 mm, particularly between 24 mm and 30 mm, for example between 20 mm and 35 mm.

4. Rotor according to claim 1, wherein the rotor body has an external periphery having a cylindrical face substantially in the form of that of a cylinder.

5. Rotor according to claim 1, wherein said rotor body (11) comprises a plurality of slots (21) each accommodating at least one magnet (22) of the set of permanent magnets.

6. Rotor according to claim 5, wherein each slot (21) is defined on its external periphery by a polar wall (31).

7. Rotor according to claim 6, wherein said polar wall (31) comprises an inner face (36) in contact with a permanent magnet (22).

8. Rotor according to claim 5, wherein two adjacent slots (21) are separated by an arm (25) pertaining to said rotor body (11).

9. Rotor according to claim 8, wherein each arm (25) is connected to a polar wall (31) via a bridge (32).

10. Rotor according to claim 9, wherein a minimum thickness (L1) of a bridge (32), measured in a radial direction, is strictly lower than a minimum thickness (L2) of a corresponding polar wall (31) measured in a radial direction.

11. Rotor according to claim 9, wherein a minimum thickness (L1) of a bridge (32), measured in a radial direction, is strictly lower than a minimum thickness (L3) of an arm (25) measured in an orthoradial direction.

12. Rotor according to claim 9, wherein a ratio between a minimum thickness (32) of a bridge (32) and a minimum thickness (L3) of an arm (25) ranges between 30% and 80%.

13. Rotor according to claim 9, wherein a ratio between a minimum thickness (L1) of a bridge measured in a radial direction and the external radius of the rotor ranges between 6% and 15%, particularly between 8% and 10%.

14. Rotor according to claim 1, wherein said permanent magnets (22) are made of rare earth.

15. Electrical rotating machine comprising a coiled stator and a rotor (10) such as defined according to claim 1.

16. Rotor according to claim 2, wherein an external diameter of said rotor (10) ranges between 20 mm and 50 mm, particularly between 24 mm and 30 mm, for example between 20 mm and 35 mm.

17. Rotor according to claim 2, wherein the rotor body has an external periphery having a cylindrical face substantially in the form of that of a cylinder.

18. Rotor according to claim 3, wherein the rotor body has an external periphery having a cylindrical face substantially in the form of that of a cylinder.
